(19) United States
(12) Patent Application Publication
(10) Pub. No.: US 2025/0045836 A1
(43) Pub. Date: Feb. 6, 2025

(54) Momentum Trading Using Deep Reinforcement Learning

(71) Applicant: Data-Core Systems, Inc., Bristol, PA (US)

(72) Inventors: Kaustav Bose, West Bengal (IN); Kundan Kumar, West Bengal (IN); Alo Ghosh, Menlo Park, CA (US)

(21) Appl. No.: 18/778,937

(22) Filed: Jul. 20, 2024

(30) Foreign Application Priority Data
Aug. 3, 2023 (IN) 202311052251

(51) Int. Cl. G06Q 40/06; G06Q 40/04

(52) U.S. Cl. CPC G06Q 40/06; G06Q 40/04

(57) ABSTRACT

The present disclosure describes effective strategies for portfolio management that utilize innovative stock selection and transaction approaches using Deep Reinforcement Learning. Embodiments include creating a candidate set of high momentum stocks determined through momentum scores and using two or more Deep Reinforcement Learning algorithms to generate trading signals for the candidate set. These trading signals are then used to manage the portfolio by adding or removing stocks to/from the portfolio and/or adjusting their weights in the portfolio.

### CROSS REFERENCE TO RELATED APPLICATIONS

This application claims priority to Indian Provisional Patent Application No. 202311052251 titled “Momentum Trading Using Deep Reinforcement Learning Comprising Synthetic Peer Generation Techniques for Stock Price Forecasting,” filed on Aug. 3, 2023, and currently pending. The entire contents of Indian Provisional Application No. 202311052251 are incorporated herein by reference.

This application also incorporates by reference the entire contents of U.S. application Ser. No. 18/675,228, titled “Generating Synthetic Data for Machine Learning Training,” filed on May 28, 2024, and currently pending.

### SUMMARY

Quantitative trading (QT) is an investment strategy that takes a systematic approach driven by mathematical models and data analysis. In contrast to the ad hoc nature of traditional discretionary trading, QT is a more scientific and objective method for decision-making in financial markets. By relying on algorithms and quantitative analysis, QT offers a structured framework for evaluating and executing trades, enhancing precision, and minimizing emotional biases. Aspects of QT are described in E. P. Chan, “Quantitative trading: how to build your own algorithmic trading business,” John Wiley & Sons (2021).

With recent advances in the capabilities of artificial intelligence (AI) and machine learning (ML) technologies, QT has gained popularity in recent years, commanding a substantial share of trading volumes in both developed and developing markets. For instance, in developed markets such as the U.S., QT accounts for over 70% of trading volumes, while in developing markets like China, it constitutes approximately 40% of the trading volumes, as explained in S. Sun, R. Wang, and B. An, “Reinforcement learning for quantitative trading,” ACM Transactions on Intelligent Systems and Technology, vol. 14, no. 3, pp. 1-29 (2023).

Traditional QT strategies, including momentum strategies, are popular methods employed by traders and investors. Aspects of traditional QT strategies, including momentum strategies, are discussed in C. R. Harvey, S. Rattray, and O. Van Hemert, “Strategic risk management: Designing portfolios and managing risk,” John Wiley & Sons (2021). However, momentum strategies tend to only perform well in specific market conditions as explained in Daniel, Kent, and Tobias J. Moskowitz, “Momentum crashes,” Journal of Financial Economics, Vol. 122, No. 2, pp. 221-47 (2016). Another approach to trading involves utilizing signals from machine learning-based system, as described in (i) Bicheng Wang & Xinyi Zhang, “Deep learning applying on stock trading,” CS230: Deep Learning, Stanford University, CA (Spring 2021); (ii) C. Tian, “Applications of Machine Learning and Reinforcement Learning in Investment and Trading,” University of California Irvine (2020); (iii) Hambly, Ben M. and Xu, Renyuan and Yang, Huining, “Recent Advances in Reinforcement Learning in Finance” (Feb. 27, 2023); (iv) Huang, Wei, Yoshiteru Nakamori, and Shou-Yang Wang, “Forecasting stock market movement direction with support vector machine,” Computers & Operations Research, Vol. 21, No. 10, pp. 2513-2522 (2005); and (v) Abe, Masaya, and Hideki Nakayama, “Deep learning for forecasting stock returns in the cross-section,” Pacific-Asia Conference on Knowledge Discovery and Data Mining, (Jan. 3, 2018).

For example, supervised learning algorithms like the tree-based models described in G. Ke, Q. Meng, T. Finley, T. Wang, W. Chen, W. Ma, Q. Ye, and T. Y. Liu, “Lightgbm: A highly efficient gradient boosting decision tree,” 31st Conference on Neural Information Processing Systems (NIPS 2017), Long Beach, CA (Dec. 4, 2017), the support vector machines (SVM) described in Huang, Wei, Yoshiteru Nakamori, and Shou-Yang Wang, “Forecasting stock market movement direction with support vector machine,” Computers & Operations Research, Vol. 21, No. 10, pp. 2513-2522 (2005), and the deep neural networks in Abe, Masaya, and Hideki Nakayama, “Deep learning for forecasting stock returns in the cross-section,” Pacific-Asia Conference on Knowledge Discovery and Data Mining, (Jan. 3, 2018) have been used for price forecasting. In addition, Natural Language Processing (NLP) techniques that enable sentiment analysis of news articles and social media posts can offer helpful insights for making trading decisions as described in Wenbin Zhang & Steven Skiena, “Trading Strategies to Exploit Blog and News Sentiment,” Proceedings of the Fourth International AAAI Conference on Weblogs and Social Media, Vol. 4. No. 1., pp. 375-378 (2010).

There is growing demand for data-driven machine-learning techniques across various domains. One subfield of data-driven machine-learning techniques is Reinforcement Learning (RL), which offers a mathematical framework for learning from experience by iteratively interacting with an environment, taking actions, receiving feedback, and adjusting strategies to maximize cumulative rewards. Deep Reinforcement Learning (DRL) is an extension of RL that incorporates deep learning techniques to handle complex and high-dimensional data.

The present application discloses and describes new and efficient strategies for portfolio management within the domain of QT by combining a momentum trading screening approach with an innovative stock selection methodology based on DRL.

Momentum strategies rely on the assumption that existing market trends will continue. More particularly, momentum strategies are based on the idea that assets that have performed well in the recent past will continue to perform well in the near future, while assets that have performed poorly in the recent past will continue to perform poorly in the near future. The underlying principle is grounded in the assumption that market trends persist due to various factors such as investor sentiment, institutional buying or selling pressure, herd mentality and fundamental factors (e.g., consistent earnings growth, market share expansion, etc.), all contributing to the asset's performance.

However, momentum strategies come with inherent risks because stocks can abruptly reverse their direction, leading to significant losses if not managed properly. The DRL based techniques disclosed herein can help mitigate this risk by identifying early signs of potential reversals that traditional momentum strategies tend to miss. Even when a stock exhibits strong momentum (up or down), its price movement is not always smooth; the stock price can often experience pullbacks and consolidations within a long-term trend. But by accurately identifying these price movements, the DRL based approaches disclosed herein can provide more timely entry and exit signals, making the novel approaches disclosed herein more robust and adaptive to complex market dynamics as compared with the traditional approaches described in the literature identified above.

Accordingly, one aspect of the disclosed systems and methods includes, among other features, training a plurality (two or more) of Deep Reinforcement Learning (DRL) based machine learning models with a training dataset comprising one or more (or all) of (i) technical data relating to individual securities in a set of securities, (ii) fundamental data relating to the individual securities in the set of securities, (iii) macroeconomic data, and/or (iv) news relating to the individual securities in the set of securities and/or macroeconomic data from social media, newspapers, magazines, blog posts, or similar information sources.

In some embodiments, the set of securities includes a set of stocks, and in some instances, a large set of stocks. In some embodiments, the set of securities may additionally or alternatively include other securities such as bonds, mutual funds, index funds, options or other derivatives, and/or other assets. For example, the set of securities includes one or more or of (i) some or all of the stocks of the Dow Jones Industrial Average index, (ii) some or all of the stocks NASDAQ 100 index, (iii) some or all of the stocks of the S&P 500 index, (iv) any combination of the foregoing, and/or (v) any other set of stocks. Most of the examples and embodiments disclosed herein refer to stocks, but the disclosed embodiments are equally applicable to any other type of security now known or later developed that can be traded on an exchange.

Examples of DRL based machine learning models compatible for use with the disclosed systems and methods include (but are not limited to): (i) an Advantage Actor Critic (A2C) model, (ii) a Deep Q-Networks (DQN) model, and/or (iii) a Proximal Policy Optimization (PPO) model.

For example, some embodiments include, among other features, for a first Deep Reinforcement Learning (DRL) based machine learning model in a plurality of DRL based machine learning models, generating a first plurality of trading strategies based at least in part on one or more (i) technical features corresponding to individual securities in a set of securities, (ii) fundamental features of individual securities in the set of securities, and (iii) macroeconomic data. And for a second DRL based machine learning model in the plurality of DRL based machine learning models, generating a second plurality of trading strategies based at least in part on one or more (i) technical features corresponding to individual securities in the set of securities, (ii) fundamental features of individual securities in the set of securities, and (iii) macroeconomic data. The first plurality of trading strategies is different than the second plurality of trading strategies at least in part because the first and second pluralities of trading strategies are generated via different reinforcement learning algorithms (or at least differently-configured implementations of the same reinforcement learning algorithm) as described herein.

The first plurality of trading strategies and the second plurality of trading strategies associated with the first and second DRL based machine learning models, respectively, are themselves based on trading policies learned by the DRL based machine learning models. In operation, a DRL agent generates (i.e., learns) a plurality of DRL trading policies by using a DRL algorithm to interact with the aforementioned training dataset comprising (i) the technical features corresponding to individual securities in the set of securities, (ii) the fundamental features of individual securities in the set of securities, and (iii) the macroeconomic data. The trading strategies implemented by an individual DRL based machine learning model are based on the DRL trading policies learned by the DRL agent.

An individual DRL trading policy maps a state to an action. In the context of a DRL trading policy, a state corresponds to a combination of (i) technical features corresponding to individual securities in the set of securities, (ii) fundamental features of individual securities in the set of securities, and (iii) macroeconomic data. In some embodiments, an action in the context of a DRL trading policy corresponds to (i) purchasing shares of a security, (ii) selling shares of a security, and/or (iii) a neutral action, such as holding shares of a security that was previously purchased, or not purchasing any new shares of a security. In some embodiments, an action in the context of a DRL trading policy corresponds to (i) opening or closing a long position in a particular security, (ii) opening or closing a short position in a particular security, and/or (iii) taking no position, e.g., holding cash. In some instances, holding cash amounts to not opening a long position in a security or not closing a short position in a security.

In some embodiments, an individual trading strategy is based on one or more DRL trading policies learned by the DRL agent. For example, in some instances, a trading strategy corresponds to the implementation of a single DRL trading policy. In other instances, a trading strategy corresponds to the implementation of a combination of two or more DRL trading policies. In still other instances, a trading strategy corresponds to the implementation of one or more DRL trading policies with one or more other rules or constraints, such as rules or constraints that limit the portfolio weight for a certain security.

Some embodiments additionally include determining a momentum score for each security in the set of securities. Determining the momentum scores is separate from training the DRL based machine learning models to learn trading strategies. In operation, the disclosed embodiments use the momentum scores for the securities to determine the securities in the set of securities to which the trading strategies will be applied. Based on the determined momentum scores, a candidate subset of securities is selected from the set of securities. The candidate subset of securities is sometimes referred to herein as simply the “candidate subset.” In some embodiments, the candidate subset includes securities having a momentum score that satisfies a particular momentum threshold.

For example, the candidate subset may include (i) securities having a momentum score above a first (or positive) momentum threshold as a candidate security for a long position (e.g., a candidate to buy), and (ii) securities having a momentum score below a second (or negative) momentum threshold as a candidate security for short position (e.g., a candidate to sell or a candidate for a short position). In some embodiments, the total set of candidate securities in the candidate subset may be limited to some maximum number of securities. For example, the candidate subset may include a maximum number of securities having (i) the highest momentum scores above the positive momentum threshold and/or (ii) the lowest momentum scores below the negative momentum threshold. As described further herein, some embodiments may consider percentile rankings as thresholds, by, for example, selecting stocks having the highest positive momentum scores (i.e., within some top percentile of positive scores) as candidates for long positions, and selecting stocks having the highest negative momentum scores (i.e., within some top percentile of negative scores) as candidates for short positions.

Next, the plurality of DRL based machine learning models is used to generate trading signals for each security in the candidate subset and then aggregating the trading signals from the plurality of DRL based machine learning models for each security in the candidate subset. For example, some embodiments include for each security in the candidate subset, (i) generating a first set of one or more trading signals for the security by applying the first plurality of trading strategies (based on a first set of DRL trading policies previously learned by a DRL agent via interaction with the aforementioned training dataset according to a first DRL algorithm) to data associated with the security, (ii) generating a second set of one or more trading signals for the security by applying the second plurality of trading strategies (based on a second set of DRL trading policies previously learned by a DRL agent via interaction with the aforementioned training dataset according to a second DRL algorithm) to data associated with the security, and (iii) generating an aggregated trading signal for the security based on the first set of one or more trading signals for the security and the second set of one or more trading signals for the security. Some embodiments are described with reference to aggregating trading signals from two sets of trading signals for ease of illustration. In operation, embodiments may aggregate trading signals from more than two sets of trading signals generated by more than two DRL based machine learning models.

In practice, the DRL agents learn the DRL trading policies on which the trading strategies are based from a large set of historical data relating to all the securities in the set of securities, whereas the DRL based machine learning models apply the trading strategies to a comparatively smaller set of current data (e.g., real time or substantially real time data) relating to the securities in the candidate subset. In this manner, the DRL based machine learning models apply the trading strategies derived from trading policies the DRL agents learned from the large set of historical data for the large set of securities to a comparatively smaller set of current data for a smaller, targeted set of securities, i.e., a the candidate set containing securities with high momentum scores.

In some embodiments, the aggregated trading signal also indicates a signal strength. For example, if the first DRL based machine learning model generated a “buy” signal for a first security, and the second DRL based machine learning model also generated a “buy” signal for the first security, then the aggregated trading signal for that first security would be stronger than the aggregated trading signal for a second security where the first DRL based machine learning model generated a “buy” signal but the second DRL based machine learning model generated a “neutral” or “sell” trading signal.

After generating the aggregated trading signals for each security in the candidate subset, some embodiments additionally include one or more of: (i) opening a long position (i.e., buying one or more shares) of a security in the candidate subset (e.g., adding shares of the security to a trading portfolio by purchasing those shares from the market), (ii) closing a long position (i.e., selling one or more shares) of a security in the candidate subset (e.g., removing shares of the security from the trading portfolio by selling those shares to the market, to the extent that the trading portfolio included one or more shares of that security), (iii) opening a short position (i.e., selling short one or more shares) of a security in the candidate subset, and/or (iv) closing a short position (i.e., buying back one or more shorted shares) of a security in the candidate subset (to the extent that the trading portfolio included one or more shorted shares of that security).

Some embodiments disclosed herein provide improvements in the functioning of a computing system configured to implement QT strategies.

For example, prior QT strategies employing machine learning models such as the ones disclosed in the literature identified earlier herein tend to focus on a large set of securities, and include training and operating a separate machine learning model for each security on which the QT strategy is focused. As a result, prior QT strategies required developing, training, and operating a large number of machine learning models that are each optimized for a separate stock.

Rather than generating separate models for each stock, the disclosed embodiments include developing, training, and operating a comparatively smaller number of models that are applicable to a large set of stocks. This comparatively smaller number of models is then applied to data from a selected subset of high momentum stocks rather than a comparatively larger data set from a comparatively larger set of stocks. Thus, the combination of the model training strategy with the momentum stock screening strategy described herein results in fewer machine learning models analyzing a smaller set of stock data as compared to prior QT strategies. As a result, the computing systems configured to manage portfolios with the disclosed embodiments described herein require far less computing resources that computing systems configured to perform various portfolio management functions with prior QT strategies.

Certain examples described herein may include none, some, or all of the above described features and/or advantages. Further, additional features and/or advantages may be readily apparent to persons of ordinary skill in the art based on reading the figures, descriptions, and claims included herein.

### BRIEF DESCRIPTION OF THE DRAWINGS

For a more complete understanding of the present disclosure and its features and advantages, reference is now made to the following description, taken in conjunction with the accompanying figures.

FIG. 1 shows an overview of a portfolio management technique that implements aspects of a method of momentum trading using a plurality of deep reinforcement learning models according to some embodiments.

FIG. 2 shows aspects of training an individual deep reinforcement learning model according to some embodiments.

FIG. 3 shows a flow chart method for momentum trading using a plurality of deep reinforcement learning models according to some embodiments.

FIG. 4 shows an example computing system configured for implementing aspects of the methods and processes disclosed herein.

### DETAILED DESCRIPTION OF THE DRAWINGS

### I. Portfolio Management Technique Overview

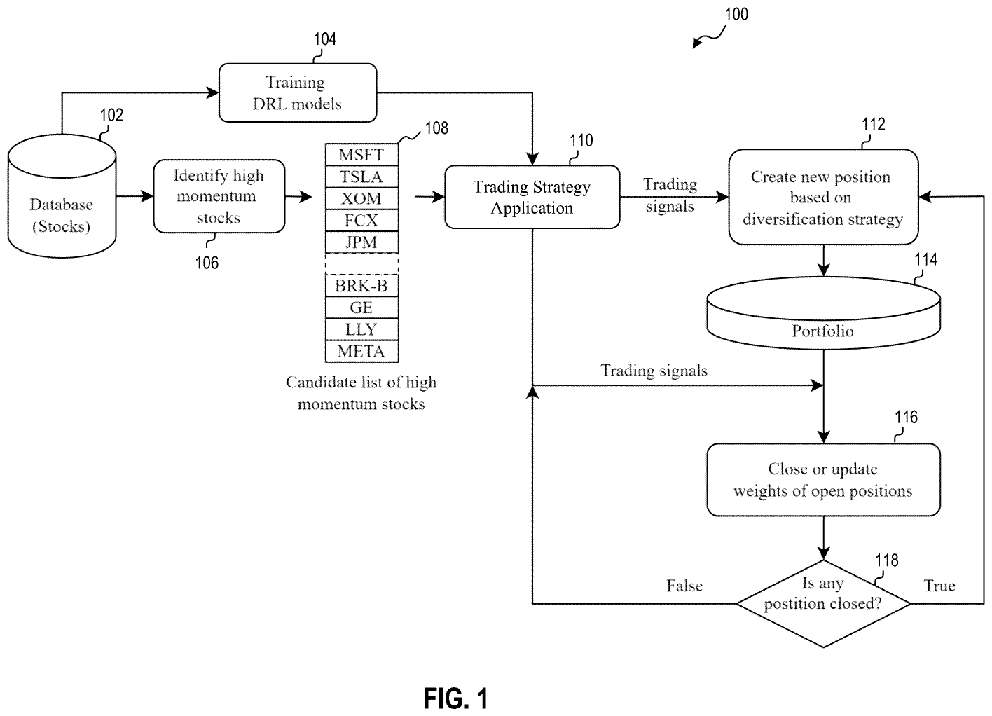

FIG. 1 shows an overview of a portfolio management technique 100 that implements aspects of a method of momentum trading using a plurality of deep reinforcement learning models according to some embodiments.

The portfolio management technique 100 includes compiling and/or maintaining a database 102 that includes information about stocks (or other securities) traded on one or more different exchanges. The database 102 contains data relevant to the stocks (or other securities), including, for each stock (or other security), one or more (or all) of: (i) the name of the stock, (ii) the stock symbol, (iii) a company name (where applicable), (iii) a sector classification, (iv) financial information relating to the stock, such cash flow, debt, income, equity, return on equity, earnings, profits, etc., (v) historical prices of the stock, etc. In some embodiments, the database 102 may additionally include macroeconomic data about the broader economy, sentiment data relating to the securities obtained from articles, social media, etc., and other data suitable for training DRL based machine learning models consistent with the approaches described herein.

The portfolio management technique 100 uses the information stored in the database 102 for two purposes: (1) a DRL Model Training Stage 104, and (2) a Momentum Stock Identification Stage 106.

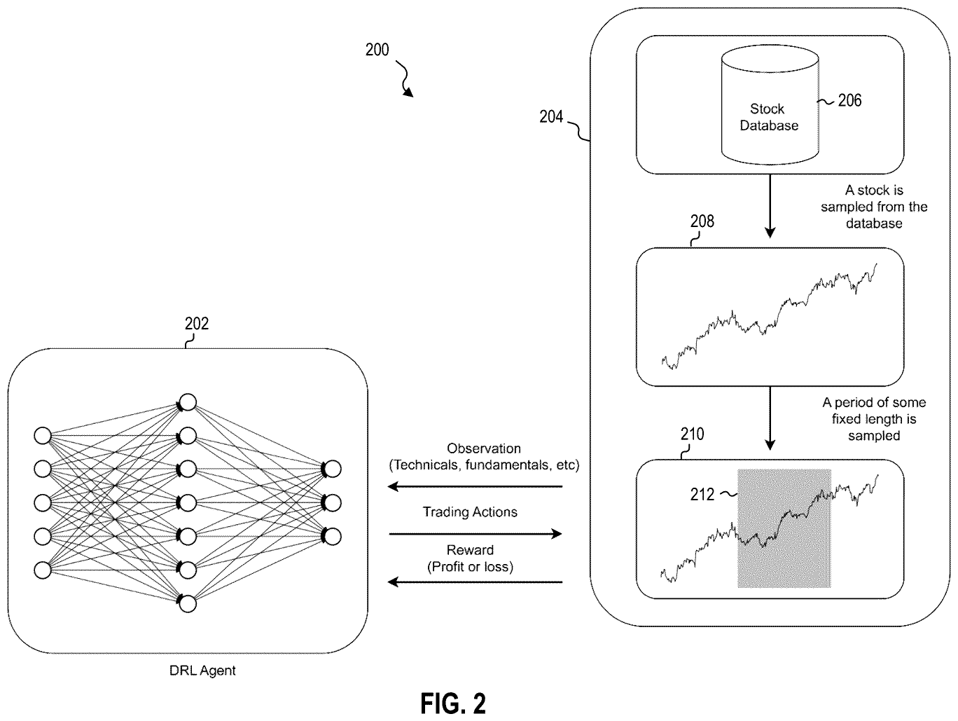

During the DRL Model Training Stage 104, the different DRL models are trained on the data from the database 102 using different DRL algorithms to generate different sets of trading strategies. As described in more detail with reference to FIG. 2, training one DRL model includes using a DRL agent (e.g., DRL agent 202 in FIG. 2) to interact with the data contained in the database 102 (referred to as environment 204 in FIG. 2) to learn DRL trading policies. In operation, the DRL agent uses a particular DRL algorithm to interact with the data contained in the database 102. In some embodiments, each DRL model uses its own DRL agent, and each DRL agent uses a different DRL algorithm. As a result, the DRL trading policies learned by each DRL agent are different.

For example, a first DRL agent uses a first DRL algorithm to generate a first set of DRL trading policies, and a second DRL agent uses a second DRL algorithm to generate a second set of DRL trading policies. Examples of the DRL algorithms used by the first DRL agent and the second DRL agent include the Advantage Actor Critic (A2C) algorithm, the Deep Q-Networks (DQN) algorithm, and/or the Proximal Policy Optimization (PPO) algorithm. However, the DRL agents may use any other DRL algorithm now known or later developed that is suitable for use in analyzing stock data to learn DRL trading policies in a manner similar to that disclosed herein. Aspects of DRL model training performed at the DRL Model Training Stage 104 and the trading strategies generated via DRL Model Training Stage 104 are described in further detail herein, including with reference to FIG. 2. The DRL trading policies learned by the DRL agents are then combined with one or more other rules or constraints (such as rules or constraints that limit the portfolio weight for a certain security) to generate trading strategies that will be applied during the Trading Strategy Application Stage 110

During the Momentum Stock Identification Stage 106, a momentum screener is employed to create a candidate subset 108 of stocks that satisfy one or more momentum thresholds. Aspects of the momentum stock identification 106 stage are described further herein, including in Section I(3).

Portfolio management technique 100 next includes a Trading Strategy Application Stage 110. During the Trading Strategy Application Stage 110, the trading strategies generated during the DRL Model Training Stage 104 are applied to data associated with the stocks (or other securities) in the candidate subset 108 generated during the Momentum Stock Identification Stage 106. In some embodiments, the data associated with the stocks (or other securities) in the candidate subset 108 includes data obtained from database 102, where the data from database 102 is data that corresponds to (or is otherwise associated with) the stocks (or other securities) in the candidate subset 108. In some embodiments, the data associated with the stocks in the candidate subset 108 additionally or alternatively includes data from sources other than database 102. For example, in some embodiments, the data may additionally or alternatively include real-time market data associated with the stock (e.g., current price, bid/ask size, bid/ask spread, trading volume, etc.) from one or more exchanges on which the stock is traded. In such embodiments, the real-time market data may be provided to the DRL models during the Trading Strategy Application Stage 110 without first storing the real-time market data in database 102.

In operation, at the Trading Strategy Application Stage 110, the set of trained DRL models (trained during the DRL Model Training Stage 104) are used to generate trading signals for individual stocks (or other securities) within the candidate subset 108 of stocks (or other securities). These trading signals include BUY, SELL, and NEUTRAL signals for individual stocks (or other securities) in the candidate subset 108. For example, for an individual stock in the candidate subset 108, each DRL model (of the plurality of trained DRL models) generates a trading signal (e.g., buy, sell, or neutral) for the individual stock based on the data associated with that individual stock.

In some embodiments, the Trading Strategy Application Stage 110 also includes, for an individual stock in the candidate subset 108, combining the trading signals generated by each DRL model of the plurality of DRL models that that individual stock into a combined trading signal for that individual stock. In some embodiments, the combined trading signal has a corresponding signal strength based on the different trading signals that were combined to generate the combined trading signal. This combined trading signal is sometimes referred to herein as an “ensembled trading signal” or an “aggregated trading signal.” Generating the combined trading signal is sometimes referred to herein as “ensembling” the individual trading signals into the “ensembled trading signal” or “aggregating” the individual trading signals into the “aggregated trading signal.”

In some embodiments, the signal strength of an ensembled trading signal is obtained by averaging the separate trading signals for the stock that were generated by the plurality of DRL models. Techniques for generating the ensembled trading signal and the corresponding signal strength of an ensembled trading signal are described in more detail herein, including Section I(4.5).

Based on these trading signals (e.g., the ensembled trading signals and/or perhaps the individual trading signals on which they are based), a portfolio 114 of long and short positions is created at the Position Creation Stage 112.

For example, in some embodiments, if the ensemble (or aggregated) trading signal for a first stock (or other security) generated at the Trading Strategy Application Stage 110 is a BUY, then at the Position Creation Stage 112, one or more shares of the first stock (or other security) are purchased and added to the portfolio 114. Buying one or more shares of the first stock (or other security) is known as opening a long position in the first stock. Similarly, in some embodiments, if the ensemble trading signal for a second stock (or other security) is a SELL, then at the Position Creation Stage 112, one or more shares of the second stock (or other security) are shorted, and the short position is added to the portfolio 114. Shorting one or more shares of the second stock (or other security) is known as opening a short position in the second stock.

In some embodiments, the portfolio management technique 100 is implemented as a long-short strategy. However, the portfolio management technique 100 is flexible and can be readily adapted to a long-only strategy by simply considering only the long (i.e., BUY) signals for opening new long positions, or readily adapted to a short-only strategy by considering only the short (i.e., SELL) signals for opening new short positions.

In some embodiments, stock positions (long and/or short) are added to the portfolio 114 while also adhering to diversification criteria. For example, in addition to considering the aggregated trading signals for the stocks in the candidate subset 108 (and their corresponding signal strengths), some embodiments additionally consider one or more diversification criteria, such as opening positions (long and/or short) for stocks from different industries to avoid overconcentration of open positions in highly correlated stocks from the same industry, restricting open positions (long and/or short) for a single stock to no more than some maximum percentage of overall portfolio value to avoid overconcentration in a single stock, and/or other diversification strategies.

Open positions for the stocks in the portfolio 114 are managed by adjusting their weights within the portfolio 114 and/or closing the positions in response to changes in ensemble trading signals provided by the Trading Strategy Application Stage 110. For example, at the Close or Update Weights of Open Positions Stage 116, the aggregated trading signals from the Trading Strategy Application Stage 110 are evaluated to determine whether to close an open position (i.e., close a long position by selling one or more shares of a stock in the portfolio 114, or closing a short position by buying back one or more shorted shares of a stock in the portfolio 114).

At decision block 118, if a particular buy or sell transaction entirely closes a position in the portfolio 114 for a particular stock, then the portfolio management technique 100 returns to the Position Creation Stage 112 to create one or more new positions (typically in a different stock) based on the ensembled trading signals generated by the Trading Strategy Application Stage 110. But if the buy or sell transaction does not entirely close a position in the portfolio 114 for a particular stock, then the portfolio management technique 100 continues to monitor the ensembled trading signals (and perhaps their signal strengths) for that particular stock to determine whether to further add to the position in the portfolio 114 that stock or remove a portion of the position in the portfolio 114 for that stock.

Existing research in Deep Reinforcement Learning (DRL) applied to stock trading primarily falls into two categories: (1) trading individual stocks and (2) portfolio weight allocation.

For example, techniques for using DRL to trade individual stocks are described in: (i) Deng, Y., Bao, F., Kong, Y., Ren, Z. and Dai, Q., 2016. “Deep direct reinforcement learning for financial signal representation and trading,” IEEE Transactions on Neural Networks and Learning Systems, Vol. 28, Issue 3, pp. 653-664 (Feb. 15, 2016); (ii) Chen, L. and Gao, Q., “Application of deep reinforcement learning on automated stock trading,” 2019 IEEE 10th International Conference on Software Engineering and Service Science (ICSESS), pp. 29-33 (Oct. 18, 2019); (iii) Wu, X., Chen, H., Wang, J., Troiano, L., Loia, V. and Fujita, H., “Adaptive stock trading strategies with deep reinforcement learning methods,” Information Sciences 538, pp. 142-158 (June 2020); and (iv) Wu, Jia et al., “Quantitative trading on stock market based on deep reinforcement learning,” 2019 International Joint Conference on Neural Networks (IJCNN), pp. 1-8 (Jul. 14, 2019). And techniques for portfolio weight allocation are described in: (i) Jiang, Zhengyao et al., “A Deep Reinforcement Learning Framework for the Financial Portfolio Management Problem,” arXiv.org (Jun. 30, 2017); (ii) Yang, Hongyang and Liu, Xiao-Yang and Zhong, Shan and Walid, Anwar, “Deep Reinforcement Learning for Automated Stock Trading: An Ensemble Strategy,” Proceedings of the First ACM Int'l Conference on AI in Finance, pp. 1-8, (Sep. 11, 2020); (iii) Soleymani, Farzan & Paquet, Eric, “Financial Portfolio Optimization with Online Deep Reinforcement Learning and Restricted Stacked Autoencoder—DeepBreath,” Expert Systems with Applications, 156:113456 (April 2020); and (iv) Park, Hyungjun & Sim, Min & Choi, Dong, “An intelligent financial portfolio trading strategy using deep Q-learning,” Expert Systems with Applications. 158:113573 (May 2020).

However, earlier applications of DRL to trading individual stocks and portfolio weight allocation do not consider or otherwise address a holistic process of portfolio management. In contrast to the earlier applications of DRL to trading individual stocks and portfolio weight allocation described in the above-listed literature, the portfolio management technique 100 summarized within the context of FIG. 1 and described in further detail herein encompasses several of the most important stages of portfolio management, including (i) stock picking, (ii) timely opening and closing positions, and (iii) allocation of weights within the portfolio.

For example, one important aspect of portfolio management is stock selection, a facet often overlooked in existing literature. The embodiments disclosed herein address shortcomings of existing approaches by developing generalized DRL models instead of stock specific models. These generalized models are capable of processing large amounts of stocks simultaneously and generating trading signals along with signal strengths, enabling systematic stock selection.

Further, the trading signals generated by the disclosed embodiments facilitate timely opening and closing of positions, and the signals strengths of the trading signals can be used (and in some instances are used) to determine the allocation of weights of individual stocks within the portfolio (i.e., deciding how much of an individual stock should be held in the portfolio in view of the total size or value of the portfolio).

By integrating these components, the novel combination of techniques disclosed herein offer a comprehensive portfolio management approach that enhances decision-making using DRL models across all stages of portfolio management from stock screening, trade execution, and portfolio updating based on changing market conditions. And as mentioned earlier, these approaches provide improvements in the functioning of a computing system configured to implement trading and portfolio management strategies at least in part by developing, training, and operating fewer machine learning models that, in operation, analyze a smaller set of stock data as compared to prior QT strategies. As a result, the computing systems configured to manage portfolios with the disclosed embodiments described herein require far less computing resources in terms of processing cycles to implement the disclosed embodiments as compared to computing systems configured to perform various portfolio management functions with the strategies described in the above-listed literature.

### 2. Deep Reinforcement Learning Framework

FIG. 2 shows aspects of a DRL framework 200 for training an individual DRL model according to some embodiments. The DRL framework 200 includes a DRL agent 202 and an environment 204. In operation, the DRL agent 202 learns to make decisions by interacting with the environment 204. In operation, the decisions learned by the DRL agent 202 are embodied in DRL trading policies, as described in further detail herein.

FIG. 2 shows aspects of training a single DRL model. In embodiments that employ two or more different DRL models, the DRL framework 200 shown and described with reference to FIG. 2 is used for each DRL model (of the multiple DRL models) employed by the various embodiments described herein.

The environment 204 includes the context or setting within which the DRL agent 202 operates. The environment 204 includes stock database 206. In some embodiments, stock database 206 is the same as or similar to database 102 (FIG. 1). As such, the information in stock database 206 is the same as or similar to the information in database 102.

For example, stock database 206 includes historical data relating to individual stocks. Historical data for an individual stock is illustrated in FIG. 2 as dataset 208. In practice, stock database 206 includes datasets that include data associated with many stocks, and thus, a dataset 208 can be extracted from the stock database 206 for each stock in the stock database 206, i.e., the stock database 206 contains a plurality of datasets 208 (one dataset for each stock). A portion 212 of the data in dataset 208 is sampled to generate a sample set 210 that can be used by the DRL agent 202 to learn DRL trading policies. This size of the sample set 210 for an individual stock in the stock database 206 corresponds to some duration of time. The sample set 210 may include data from any suitable duration of time, such as one or more days, one or more weeks, one or more quarters, one or more years, and so on.

In some embodiments, the environment 204 also includes rules, dynamics, and constraints under which the environment 204 operates. In the context of the disclosed embodiments, the environment 204 is or includes a simulation of financial market environment that includes factors such as asset prices, economic indicators, news events, etc. associated with the set of stocks contained within the stock database 206.

The DRL agent 202 is a software entity that engages in interactions with the environment 204 according to at least one of several different DRL algorithms. The DRL agent 202 represents the intelligent decision-maker within the DRL framework 200. In operation, the DRL agent 202 selects actions based on its observations of the state of the environment 204.

One objective of the DRL agent 202 is to learn a DRL trading policy. A DRL trading policy is a mapping from states (i.e., states of the environment 204) to actions (i.e., opening and/or closing positions in stocks). In operation, the DRL agent 202 seeks to learn DRL trading policies that maximize cumulative reward over time. To achieve this goal of maximizing cumulative reward over time, the DRL agent 202 uses one or more reinforcement learning algorithms to explore the environment 204, learn from experience, and adapt its behavior to achieve desired outcomes. Examples of reinforcement learning algorithms used by the DRL agent 202 include, but are not limited to, the Advantage Actor Critic (A2C), Deep Q-Networks (DQN), Proximal Policy Optimization (PPO) algorithms. For example, in some embodiments, the DRL agent 202 uses one reinforcement learning algorithm to explore the environment 204. In other embodiments, the DRL agent 202 may use two or more reinforcement algorithms to explore the environment 204, perhaps by using a first reinforcement learning algorithm for a first period of time to learn one or more trading policies, and then using a second reinforcement learning algorithm for a second period of time to learn different trading policies. In still further embodiments, the DRL agent 202 may execute multiple reinforcement learning algorithms in parallel to learn different sets of trading policies based on each reinforcement learning algorithm.

In the context of some disclosed embodiments, the DRL agent 202 is or functions as a trading bot that interacts with the financial market environment 204 by making decisions such as buying or selling stocks based on observed market conditions. In operation, the DRL agent 202 tracks the success and failure of the trades to learn the DRL trading policies. The trading strategies applied to market data for the securities in the candidate subset 108 (FIG. 1) during the Trading Strategy Application Stage 110 (FIG. 1) are based in whole or in part on the DRL trading policies learned by the DRL agent 202.

In the DRL framework 200, the interaction between the DRL agent 202 and the environment 204 is mathematically described using a Markov Decision Processes (MDP), defined by a tuple (S, A, P, R), where S is the state space, A is the action space, P is the state transition probability function, and R is the reward function.

The state space S represents the set of all possible states that the environment 204 can be in. The state captures the current representation of the environment 204, which encapsulates all (or substantially all) of the relevant information used by the DRL agent 202 for decision-making. Decision making in the context of the disclosed embodiments includes deciding whether to open or close a long or short position in a stock.

The action space A consists of all possible actions that the DRL agent 202 can take in the environment 204. In the context of the disclosed embodiments, the possible actions that the DRL agent 202 can take include, but are not limited to, one or more (or all) of (i) opening a long position (i.e., buying a stock, sometimes referred to as buying to open), (ii) closing a long position (i.e., selling a stock, sometimes referred to as selling to close), (iii) opening a short position (i.e., selling a stock short, sometimes referred to as selling to open), and (iv) closing a short position (i.e., buying back a shorted stock, sometimes referred to as buying to close). In some embodiments, the possible actions may additionally include taking no action for a particular stock, such as (i) holding a long position (i.e., deciding not to sell a stock), (ii) holding a short position (i.e., deciding not to buy back a shorted stock), (iii) deciding not to open a long position (i.e., deciding not to buy a stock), and/or (iv) deciding not to open a short position (i.e., deciding not to sell a stock short). In some examples, taking no action for a particular stocks is the result of having a “neutral” outlook on the stock rather than a “buy” or “sell” outlook on the stock.

The state transition probability function P defines the probability of transitioning from one state to another state given a particular action. In the context of the disclosed embodiments, P(s′|s, a) is the probability of transitioning to state s′ given the current state s and the DRL agent's 202 action a.

The reward function R defines the reward the DRL agent 202 receives after taking a particular action a when the environment 204 is in a specific state s. In some examples, the reward for opening a long position in a stock (i.e., buying the stock) is positive if the value of the stock increases after opening the long position. Similarly, the reward for opening the long position in the stock is negative if the value of the stock declines after opening the long position. Likewise, the reward for opening a short position in the stock (i.e., selling the stock short) is positive if the value of the stock declines after opening the short position, and the reward for opening the short position in the stock is negative if the value of the stock increases after opening the short position.

In the Markov decision process, the objective of the DRL agent 202 is to find a decision making policy (i.e., a DRL trading policy) for the DRL agent 202 so that the rewards that the DRL agent 202 realizes from its actions increase over time, and preferably are maximized over time. But because it can be difficult to determine whether rewards have been maximized, some embodiment focus on learning DRL trading policies that increase rewards over time.

The process of maximizing (or at least increasing) rewards over time can be characterized in the context of episodes, cumulative rewards, and trading policies.

An episode refers to a single run or sequence of interactions between the DRL agent 202 and the environment 204, starting from an initial state of the environment 204 and ending when a termination condition is met. In the context of the disclosed embodiments, an episode is a fixed trading period between a starting date (or time) and an end date (or time). This trading period can be any suitable duration of time, such as one or more minutes, one or more hours, one or more days, one or more weeks, one or more months, one or more quarters, one or more years, and so on.

Cumulative reward refers to the aggregated sum of rewards obtained by the DRL agent 202 over the course of an episode.

The DRL trading policy (sometimes referred to as just a policy) T defines the DRL agent's 202 strategy for selecting actions in different states. In the context of the disclosed embodiments, the DRL trading policy is a mapping from states to actions where, π(s)=a. In operation, π(s)=a means that action a is selected by the DRL trading policy π when state s exists in the environment 204.

In operation, one objective of the DRL agent 202 is to learn a DRL trading policy π* that maximizes the expected cumulative reward, or at least causes the expected cumulative reward to increase over time. In operation, the DRL agent 202 may learn many different DRL trading policies by taking different trading actions based on its observations of the environment 204 and monitoring the rewards generated by those trading actions over time.

As described within the context of the portfolio management technique 100 of FIG. 1, and explained in further detail herein, some embodiments include multiple DRL agents 202, where each DRL agent 202 has used a different DRL algorithm to learn a different set of DRL trading policies from the environment 204. These different DRL trading policies form the basis for different trading strategies implemented at the Trading Strategy Application Stage 110.

As mentioned previously, the DRL trading policies learned by the DRL agents may be combined with each other and/or with other constraints or rules to form a trading strategy. For example, a DRL agent may learn a DRL trading policy that suggests a particular action (e.g., opening a long position in a stock) based on some state (e.g., a combination of conditions relating to prior stock prices, technical information about the stock, fundamental information about the stock, broader macroeconomic conditions, technical and/or fundamental information of related stocks, and/or sentiment from publications, social media, etc.). In some embodiments, a trading strategy corresponds to a DRL trading policy in combination with one or more (i) other DRL trading policies and/or (ii) other rules and/or constraints that are separate from the policies learned by the DRL agent. For example, in some embodiments, a portfolio manager may place limits on the portfolio weight of an individual stock, or limits on how many stocks within the same industry should be held in the portfolio. Or for diversification purposes, the portfolio may be required to hold stocks from companies in one or more specific industries. The DRL trading policies learned by the DRL agents can be combined with these additional rules and/or constraints to generate the trading strategies that are applied during the Trading Strategy Application Stage 110. In some embodiments, and as described further herein, additional portfolio management driven constraints may be further applied when considering whether to open a new long position, increase or reduce an existing long position, close an existing long position, open a new short position, increase or reduce an existing short position, and/or close an existing short position.

### 3. Identifying High Momentum Stocks

As mentioned earlier, one aspect of the portfolio management technique 100 of FIG. 1 includes the Momentum Stock Identification Stage 106 where a momentum screener is employed to create a candidate subset 108 (FIG. 1) of stocks that satisfy one or more momentum thresholds.

In operation, a database of stocks (e.g., database 102 from FIG. 1) traded on one or more exchanges is created by gathering data on stocks, including their symbols, company names, sector classifications, financial information, historical prices and volume. This database of stocks is regularly updated with new data and also new stock listings.

As described earlier, aspects of the disclosed embodiments include identifying a list of high-momentum candidate stocks (e.g., candidate subset 108) from the database (e.g., database 102). In some embodiments, identifying the list of high-momentum candidate stocks is done by assigning a momentum score to each stock in the database (or to at least some stocks in the database).

In some embodiments, a total momentum score (sometimes referred to herein simply as the “momentum score” for the stock) is computed by combining both a fast momentum score and a slow momentum score for the stock.

The fast momentum score for a stock focuses on short-term price movements and trends of the stock. In operation, determining the fast momentum score for a stock involves calculating returns for the stock over a relatively shorter time period, for example, one or more hours, one or more days, one or more weeks, or one month.

By contrast, the slow momentum score for a stock looks at longer-term price movements and trends of the stock. In operation, determining the slow momentum score for a stock involves calculating returns for the stock over relatively longer time horizons, such as multiple months, one or more quarters, or perhaps one or more years.

In some embodiments, the price returns for a stock are computed by excluding the most recent month's performance. To adjust for risk, some embodiments also include dividing both the fast momentum score for the stock and the slow momentum score for the stock by a volatility factor for the stock. The volatility factor for the stock is determined by computing the annualized standard deviation of daily returns for the stock over the past few years, such as the past two or three years. The daily return for the stock on a particular day is equal to that day's closing price divided by the previous day's closing price minus 1, i.e., daily return=(today's closing price/yesterday's closing price)−1.

In some embodiments, the fast momentum score for a stock is calculated according to Equation 1.

$$Fast momentum = \frac{1 month return ( excluding recent 1 month )}{Volatility} \qquad Equation 1$$

And in some embodiments, the slow momentum score for a stock is calculated according to Equation 2.

$$Slow momentum = \frac{6 month return ( excluding recent 1 month )}{Volatility} \qquad Equation 2$$

In some embodiments, the risk-adjusted price momentums of the stocks in the database for both time horizons are then standardized into z-scores by subtracting the mean and then dividing the standard deviation of momentums of all stocks in the database according to Equation 3.

$$zscore of momentum of stock X = \frac{\begin{matrix}momentum of stock X - Mean of momentums \\ of all stocks in the database\end{matrix}}{\begin{matrix}Standard deviation \\ of momentums of all stocks in the database\end{matrix}} \qquad Equation 3$$

The final momentum score for the stock in some embodiments is the evenly weighed combination of the two z-scores calculated according to Equation 4.

$$Momentum score = \frac{zscore of fast momentum + zscore of slow momentum}{2} \qquad Equation 4$$

After computing the final momentum score for each stock (sometimes referred to herein as simply the “momentum score” for the stock) in the database, the stocks are ranked based on their momentum scores. These momentum scores are used to determine which stocks are added to the candidate subset 108 (FIG. 1) for subsequent analysis at the Trading Strategy Application Stage 110 (FIG. 1).

In some embodiments, stocks with higher momentum scores (e.g., momentum scores above a first threshold score) are added to the candidate subset 108 as candidate stocks for a long position. Some embodiments additionally or alternatively include adding stocks with lower momentum scores (e.g., momentum scores below a second threshold score) to the candidate subset 108 as candidates for a short position.

For example, in some embodiments, the momentum score for a stock takes a value between −1 and 1. In some examples, stocks having a momentum score above 0.75 are candidate stocks for a long position, and stocks having a momentum score below −0.75 are candidate stocks for a short position. Other examples may use different values than 0.75 for the first threshold (the long threshold) or −0.75 for the second threshold (the short threshold). Further, other examples may use different ranges for the momentum scores (e.g., −100 to +100) or other suitable ranges. And other thresholds suitable for use with such different ranges may be employed as well.

In some embodiments, the momentum score may not have predefined range. In such embodiments, a percentile can be used as a threshold. For example, the momentum score computed via Equation 4 will not have a set, predefined range. However, all of the positive momentum scores calculated via Equation 4 can be sorted by their percentile, and stocks with the highest positive momentum scores (e.g., in the top 75^{th} percentile or the top 90^{th} percentile) are designated as candidate stocks for a long position. And all of the negative momentum scores calculated via Equation 4 can be sorted by their percentile, and stocks with the highest negative momentum scores (e.g., in the top 75^{th} percentile or the top 90^{th} percentile) are designated as candidate stocks for a short position. In such configurations, the percentiles function as thresholds that are used for designating candidate stocks for long and/or short positions.

For diversification purposes, some embodiments also include grouping the stocks in the database (e.g., database 102) into two or more industry and/or sector groups, and then, for each industry/sector group, (i) adding stocks in the industry/sector group having higher momentum scores (e.g., momentum scores above a first threshold score) to the candidate subset 108 as candidate stocks for a long position for that industry/sector group, and/or (ii) adding stocks in the industry/sector group having lower momentum scores (e.g., momentum scores below a second threshold score) to the candidate subset 108 as candidate stocks for a short position for that industry/sector group.

In some embodiments, the candidate subset 108 is updated on a regular or semi-regular basis to reflect changing market conditions. For example, a first stock may have been previously added to the candidate subset 108 as a candidate stock for a long position because the momentum score for that first stock was above the first threshold score. But if the momentum score for that first stock later falls below the first threshold score, some embodiments include removing that first stock from the candidate subset 108 (or even removing the first stock from the portfolio 114 altogether). Further, if the momentum score for that first stock later falls below the second threshold score, some embodiments include adding that first stock back to the candidate subset 108, but as a candidate stock for a short position rather than a candidate stock for a long position. In this manner, individual stocks may be added and removed from the candidate subset 108 as candidate stocks for long and/or short positions as the momentum scores for the stocks change over time.

### 4. Training DRL Models and Generating Trading Signals

As mentioned previously, the disclosed embodiments include generating trading signals based on the application of trading strategies (e.g., at the Trading Strategy Application Stage 110) to current (e.g., real time or substantially real time) market data for securities in the candidate subset 108, where the trading strategies are based at least in part on DRL trading policies learned by a DRL agent 202 that uses one or more DRL algorithms to interact with an environment 204 containing historical market data. Aspects of training the DRL models and using the trained DRL models to generate trading signals are described in this section.

### 4.1 Training Data

The embodiments described herein employ DRL models that rely on deep neural networks. Deep neural networks rely of thousands of parameters and demand enormous amounts of data for effective training. As such, the availability and quality of training data is important for achieving high-performance models.

However, the quantity and quality of data available can vary for individual stocks. Sometimes, there is not sufficient data for training robust models independently for each stock. This may be especially true for newer companies with very limited historical data available.

For situations where one or more stocks lack sufficient historical data for use in training, some embodiments employ a cross-sectional approach where, instead of developing separate models for each stock (which is typical in prior approaches), a universal model is trained on a unified dataset that includes data for all stocks in the database. Aggregating the data into a unified dataset in this manner bolsters the amount of data available for use in training the DRL model. A DRL model that has been trained with the combined data, i.e., the unified dataset, (instead of individual stock data separately) consistent with the disclosed embodiments is able to generalize across many different stocks and learn patterns and relationships common across various stocks.

### 4.2 State Space

The state space includes a variety of different features to represent current market conditions. In practice, a particular “state” corresponds to a combination of many features that having specific values or values within specific ranges. In some embodiments, a particular state may correspond to a combination of hundreds or even thousands of different features having various corresponding values. Aspects of some of the features are described below. However, the features described below are just examples of some of the features that can be analyzed. Some embodiments may additionally or alternatively use other features not described in detail herein.

### 4.2.1 Technical Features

Technical features for an individual stock include indicators derived from historical prices and trading volume. Examples of technical features include, but are not limited to, exponential moving averages (EMA), relative strength index (RSI), Bollinger Bands, MACD (Moving Average Convergence Divergence), etc. These and other examples of technical features are described in Murphy, John J., “Technical analysis of the financial markets: A comprehensive guide to trading methods and applications,” Penguin (1999). In operation, the disclosed embodiments can use any technical feature(s) now known or later developed that is/are suitable for use in training a DRL model to develop DRL trading policies.

### 4.2.2 Macroeconomic Features

Macroeconomic features include broader economic and market-related variables. Examples of macroeconomic features include, but are not limited to, Gross Domestic Product (GDP) growth, inflation rate, unemployment rate, interest rates, commodity prices (e.g., oil prices), currency exchange rates, bond yields (e.g., 2-year and 10-year U.S. Treasury bond yield), market indices (e.g., S&P 500), volatility indices (e.g., VIX), etc. In operation, the disclosed embodiments can use any macroeconomic feature(s) now known or later developed that is/are suitable for use in training a DRL model to develop DRL trading policies.

### 4.2.3 Fundamental Features

Fundamental features include and/or relate to the underlying financial health and performance of individual companies. Examples of fundamental features include, but are not limited to, revenue growth rate, return on equity (ROE), debt-to-equity ratio, price-to-earnings (PE) ratio, price-to-book (PB) ratio, price-to-earnings growth (PEG) ratio, dividend yields, etc. In operation, the disclosed embodiments can use any fundamental feature(s) now known or later developed that is/are suitable for use in training a DRL model to develop DRL trading policies.

### 4.2.4 Sentiment Features

Sentiment features include features derived from various information sources, such as news articles, social media posts, analyst opinions, etc. Some embodiments employ natural language processing (NLP) techniques to preprocess textual data from the information sources. In some embodiments, the NLP techniques include splitting input text into individual words or subwords called tokens. After generating the tokens, each token is converted into a numerical representation called an embedding. The token embeddings are fed into a pre-trained transformer model, such as a Bidirectional Encoder Representations from Transformers (BERT) model, which outputs a sentiment score. Aspects of using a BERT model to generate and output the sentiment score are described in Tunstall, L., Von Werra, L. and Wolf, T., “Natural language processing with transformers,” O'Reilly Media, Inc. (2022). In operation, the disclosed embodiments can use any type of NPL technique now known or later developed that is suitable for determining sentiment scores from natural language inputs that can be used in training a DRL model to develop DRL trading policies.

### 4.2.5 Options Features

Options features include metrics such as implied volatility, open interest, put/call ratio, etc. In operation, the disclosed embodiments can use any option feature(s) now known or later developed that is/are suitable for use in training a DRL model to develop DRL trading policies.

### 4.3 Action Space

The action space represents the possible trading decisions available to the DRL agent 202. In some embodiments, the trading action is modeled as a discrete variable which can take three values {−1, 0, 1}, where −1 signifies SELL, 0 indicates NEUTRAL, and 1 denotes BUY. Some embodiments may include more or fewer actions. For example, some embodiments may utilize only a buy action and a sell action. Some embodiments may implement more complicated actions, such as open a long position, close a long position, open a short position, and close a short position. Some embodiments may additionally or alternatively implement combinations of actions, such as opening a long position and buying a put option to protect the long position, or opening a short position and buying a call option to protect the short position. The action space may additionally or alternatively include any other one or more actions or combinations of actions now known or later developed that are suitable for managing a portfolio of stocks and/or other securities.

### 4.4. Training the DRL Agent

As mentioned earlier, FIG. 2 shows aspects of a Deep Reinforcement Learning (DRL) framework 200 for training an individual DRL model according to some embodiments. In operation, aspects of using a DRL agent 202 to train the DRL model are conducted during an episode. As explained earlier, an episode refers to a single run or sequence of interactions between the DRL agent 202 and the environment 204, starting from an initial state of the environment 204 and ending when a termination condition is met. In the context of some embodiments, an episode is a fixed trading period between a starting date (and/or time) and an end date (and/or time). This trading period can be any suitable duration of time, such as one or more minutes, one or more hours, one or more days, one or more weeks, one or more months, one or more quarters, one or more years, and so on.

During training of the DRL model with the DRL agent 202, at the start of each episode, a stock from the stock database 206 is sampled (sometimes randomly sampled) from the database 206 to obtain a dataset 208 for that individual stock. As mentioned earlier, the stock database 206 contains a plurality of datasets 208, including at least one dataset for each stock in the stock database 206. A portion 212 of the data in a dataset 208 is sampled to generate a sample set 210 with which the DRL agent 202 interacts during the episode. This size of the sample set 210 for an individual stock in the stock database 206 corresponds to some duration of time 212. The sample set 210 may include data from any suitable duration of time 212, such as one or more days, one or more weeks, one or more quarters, one or more years, and so on. In some embodiments, the duration of time 212 is a one year period data sampled from the dataset 208 available for that stock in the stock database 206.

During each episode, the DRL agent 202 interacts with the environment 204 (e.g., the sample sets 210 from the environment 204) by observing the state of the environment 204, selecting trading actions based on a current DRL trading policy, and receiving rewards in terms of profit or loss resulting from the trading action.

This process of executing trades (according to the trading policy) based on the state of the environment 204 collects experiences in the form of state-action-reward-next state tuples. Then batches of these experiences are used to update the DRL trading policy parameters of the neural network of the DRL agent 202 through backpropagation to improve the current DRL trading policy. This approach allows the DRL agent 202 to learn and improve upon DRL trading policies over time to develop trading strategies across different stocks and time periods, thereby promoting generalization and adaptability.

### 4.5 Generating Trading Signals and Signal Strengths

In some embodiments, the DRL model is trained by using one or more different DRL algorithms such as the Advantage Actor Critic (A2C), Deep Q-Networks (DQN), Proximal Policy Optimization (PPO) algorithms with the DRL agent 202. In operation, the DRL agent 202 can use any DRL algorithm now known or later developed that is suitable for learning, generating, or otherwise developing DRL trading policies and/or trading strategies based thereupon.

In some embodiments, (i) a first DRL agent uses a first DRL algorithm (e.g., the A2C algorithm) to interact with the environment 204 and generate (or learn) a first set of trading strategies, (ii) a second DRL agent uses a second DRL algorithm (e.g., the DQN algorithm) to interact with the environment 204 and generate (or learn) a second set of trading strategies, and (iii) a third DRL agent uses a third DRL algorithm (e.g., the PPO algorithm) to interact with the environment 204 and generate (or learn) a third set of trading strategies.

In some embodiments, a single DRL agent may use multiple DRL algorithms. For example, the single DRL agent may use (i) a first DRL algorithm (e.g., the A2C algorithm) to interact with the environment and generate (or learn) a first set of trading strategies, (ii) a second DRL algorithm (e.g., the DQN algorithm) to interact with the environment and generate (or learn) a second set of trading strategies, and (iii) a third DRL algorithm (e.g., the PPO algorithm) to interact with the environment and generate (or learn) a third set of trading strategies.

In some embodiments, a DRL model implementing a trading strategy is configured to generate a trading signal (e.g., a BUY signal, a SELL signal, and/or a NEUTRAL signal) in response to detecting a particular state. In some instances, the state corresponds to a complex combination of tens, hundreds, thousands, or more different features, including but not limited to any of the technical, fundamental, macroeconomic, and/or sentiment features disclosed herein, or any other feature now known or later developed that is suitable for use in generating trading signals consistent with a trading strategy.

The BUY-NEUTRAL-SELL signals generated from the trained DRL models (sometimes referred to herein as DRL based machine learning models, or DRL models) are combined through an ensemble method, such as the ensembling processes described earlier.

In some embodiments, during the ensembling processes, each BUY, NEUTRAL, or SELL signal is associated with numbers 1, 0, and −1, respectively. The ensembled signal is obtained by taking the mean of the separate trading signals produced by all the individual DRL models. The ensemble trading signal (e.g., the mean of the separate trading signals) is interpreted as: (i) a BUY signal if the ensemble trading signal is positive; (ii) a NEUTRAL if the ensemble trading signal is equal to zero; and (iii) a SELL if the ensemble trading signal is negative.

For example, where five DRL models generated a separate trading signal for Apple stock (ticker symbol AAPL), where three of the five models generated a BUY signal, one of the five models generates a NEUTRAL signal, and one of the five models generated a SELL signal, then the final ensembled signal is calculated according to [3×1+1×0+1×(−1)]/5=0.4. This ensembled signal of 0.4 is interpreted as a BUY signal for AAPL.

In operation, this ensemble process not only aggregates multiple trading signals from different DRL models, but the aggregated trading signal also provides a measure of signal strength. For example, the signal strength in some embodiments is the absolute value of the ensemble (or aggregated) trading signal, or perhaps based at least in part on the absolute value of the ensemble (or aggregated) signal.

As an example, if the ensemble SELL signal for a first stock has a value −0.8, and the ensemble SELL signal for a second stock has a value of −0.4, then the SELL signal for the first stock is stronger than the SELL signal for the second stock because |−0.8|>|−0.4|. Similarly, if the ensemble BUY signal for a third stock has a value of 0.4 and the ensemble BUY signal for a fourth stock has a value of 0.6, then the fourth stock has a stronger BUY signal than the third stock because |0.6|>|0.4|.

In some embodiments, stocks with stronger trading signals will be given preference for inclusion in the portfolio over stocks having weaker trading signals. In some instances, when a position is created in the portfolio, the weight of that position in the portfolio is (or at least can be) determined by the trading signal strength of the stock corresponding to the position.

For example, when opening a long position for a stock in the portfolio, the number of shares purchased when opening the long position may be based at least in part on the signal strength of the BUY trading signal for that stock. For instance, if the ensemble BUY signal for a first stock has a value of 0.4 and the ensemble BUY signal for a second stock has a value of 0.6, then the second stock has a stronger BUY signal than the first stock. Thus, some embodiments may including opening a long position in both the first stock and the second stock, where the value of the long position in the second stock (i.e., number shares multiplied by the price per share) is greater than the value of the long position in the first stock.

### 5. Portfolio Management Using Trading Signals

In some embodiments, the candidate subset 108 (FIG. 1) of high momentum stocks is generated on a regular or semi-regular basis. For example, the candidate subset 108 may be updated on a daily, weekly, monthly, bi-monthly, quarterly, or other basis.

In some embodiments, long and/or short positions for individual stocks are created in the portfolio 114 (FIG. 1) based on the trading signals generated by a plurality DRL models (i.e., a set of two or more DRL models) during the Trading Strategy Application Stage 110 (FIG. 1) for the stocks in the candidate subset 108 (FIG. 1).

In some instances, portfolio weights are allocated to individual positions based on the signal strengths of the trading signals (BUY, SELL, etc.). In some embodiments, the trading signals during the Trading Strategy Application Stage 110 are generated on a regular or semi-regular basis (e.g., hourly, every other hour or few hours, daily, every other day or few days, weekly, etc.) using the trading strategies based on the DRL trading policies generated (i.e., learned) by the DRL agents 202 (FIG. 2). The portfolio weight for individual stocks in some embodiments based at least in part on the trading signal strengths.

If there is a change in the trading signal strength for an individual stock, the weight for that stock in the portfolio 114 is (or at least can be) updated accordingly. In some embodiments, updating the portfolio weight for a particular stock includes, for example, any one or more (or all) of: (i) adding more shares of the stock to a long position (i.e., buying more shares) when the trading signal strength for that stock increases, (ii) removing some (but perhaps not all) shares of a stock from a long position (i.e., selling some shares) when the trading signal strength for that stock declines, (iii) adding more shares of the stock to a short position (i.e., shoring more shares) when the trading signal strength for that stock declines, and/or (iv) removing some (but perhaps not all) shares of the stock from a short position (i.e., buying back some shares) when the trading signal strength for that stock increases.

In some instances, if there is a complete reversal in the trading signal strength for a specific stock, the corresponding position for that stock is closed. For example, if the portfolio includes a long position in a first stock, and the trading signal for that first stock changes from a positive (BUY) value to a negative (SELL) value, some embodiments include selling all of the shares in the long position (i.e., closing the long position) for that first stock. Similarly, if the portfolio includes a short position in a second stock, and the trading signal for that second stock changes from a negative (SELL) value to a positive (BUY) value, some embodiments include buying back all of the shares in the short position (i.e., closing the short position) for that second stock.

A position can also be closed at any time if a stop-loss is triggered. For example, when the portfolio has a long position in a first stock where the current price of the first stock is $10 per share, and where the portfolio is configured with a stop order for the first stock at $8 per share, some embodiments include closing the long position in that first stock (i.e., selling all the shares of that first stock in the position) in response to the price falling to $8 per share even if the trading signal for that first stock may still have a positive (BUY) value. Similarly, when the portfolio has a short position in a second stock where the current price of the second stock is $10 per share, and where the portfolio is configured with a stop order for the second stock at $12 per share, some embodiments include closing the short position in that second stock (i.e., buying back all the shares of that second stock in the position) in response to the price rising to $12 per share even if the trading signal for that second stock may still have a negative (SELL) value.

In some embodiments, when a position is closed, a new position (with a different stock) is added as a replacement for the recently-closed position. In operation, the new stock is selected from the candidate subset 108 based at least in part on the signal strength of the trading signals of the stocks in the candidate subset 108.

In some embodiments, opening new positions, closing existing positions, and/or adjusting the positions happens when the candidate subset 108 is updated, which may include adding and/or removing stocks from the candidate subset 108 and/or updating the trading signals for the stocks in the candidate subset 108.

Additional aspects of the three main steps, i.e., opening positions, adjusting the weight allocation of positions, and closing positions, are described below.

### 5.1 Adding Shares of Stocks to the Portfolio

As explained above, stocks are added to the portfolio 114 (FIG. 1) based on the BUY (for long positions) and/or SELL (for short positions) signals generated by the ensembled trading signals generated by the DRL models during the Trading Strategy Application Stage 110 (FIG. 1).

In some instances, only BUY signals on positive momentum stocks in the candidate subset 108 and SELL signals on negative momentum stocks in the candidate subset 108 are considered when opening new long and short positions, respectively. Preference is given to stocks with higher signal strength, as described above, indicating greater potential for favorable returns.

In some embodiments, and as described earlier, stocks are included in the portfolio 114 additionally based on a diversification criteria that aims to incorporate stocks from different industries and/or avoid an overconcentration of an individual stock or a set of highly correlated stocks from the same industry.

5.2 Weight Assignment within the Portfolio

In some embodiments, weights of the positions in the portfolio 114 are determined based on the signal strengths of the trading signals generated by the set of one or more DRL agents 202.

The weight of a position corresponds at least in part to the value of the position as a percentage of the total value of the portfolio. In one example, if the total value of the portfolio 114 is $50 MM, and the total value of a first long position for a first stock is $5 MM, then the weight of that first stock in the portfolio 114 is 10% (i.e., $5 MM/$50 MM). In another example where the total value of the portfolio 114 is $50 MM, and the total value of a second long position for a second stock is $1 MM, the weight of that second stock in the portfolio 114 is 2% (i.e., $1 MM/$50 MM). Portfolio weights could be calculated by other metrics as well.

In some embodiments, portfolio weights for individual stocks in the portfolio 114 are calculated by applying the softmax function to the ensembled signal strengths generated during the Trading Strategy Application Stage 110 (FIG. 1). The softmax function takes as input a vector z of K real numbers, and normalizes it into a probability distribution consisting of K probabilities proportional to the exponentials of the input numbers. Aspects of applying the softmax function are described by Goodfellow, Ian et al., “6.2.2.3 Softmax Units for Multinoulli Output Distributions,” Deep Learning, pp. 180-184, MIT Press, ISBN 978-0-26203561-3 (2016).

In operation, softmax converts the raw trading signal strengths to numbers that add up to 1 where each number represents a target weight of the corresponding stock in the portfolio. In some embodiments, the softmax expression for the weight of the jth constituent stock in the portfolio 114 is calculated according to Equation 5.

$${w}_{j} = \frac{{e}^{{s}_{j}}}{{\sum }_{i = 1}^{n} {e}^{{s}_{i}}} , \qquad Equation 5$$

where the s₁, . . . , sₙ, are signal strengths of portfolio constituents.

Using the softmax function in this manner ensures that the weights for each stock in the portfolio 114 are proportional to their respective trading signal strengths. In operation, the allocation of the stocks in the portfolio 114 can be updated (and in some instances is updated) based on the calculated weights so that stocks with stronger trading signals can have greater weights in the overall portfolio 114 than stocks with weaker trading signals.

5.3 Removing Shares of Stocks from the Portfolio

In some embodiments, a stock is removed from the portfolio 114 in response to a trading signal reversal for the stock.

For example, and as described earlier, a long position may be closed (and the shares of that long position removed from the portfolio) when the trading signal for the stock associated with the long position changes from a BUY signal to a SELL signal. Similarly, a short position may be closed (and the shorted shares for that short position removed from the portfolio) when the trading signal the stock associated with the short position change from a SELL signal to a BUY signal.

Additionally, in some embodiments, stocks can be removed from the portfolio if they trigger stop-loss.

### 6. Example Methods

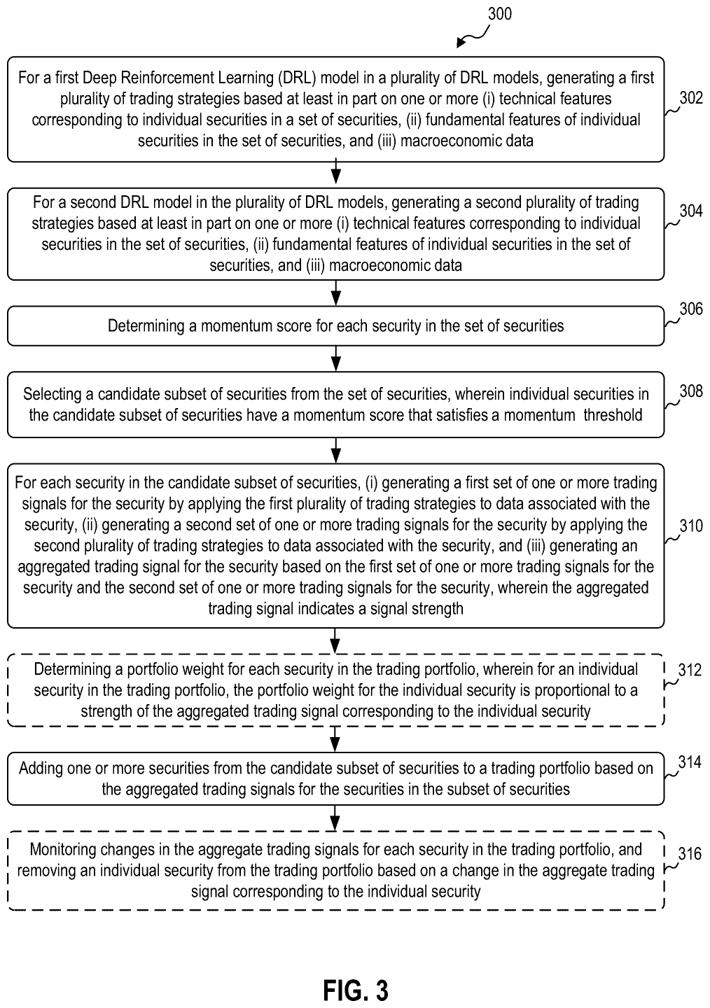

FIG. 3 shows a flow chart method 300 for momentum trading using a plurality of deep reinforcement learning models according to some embodiments.

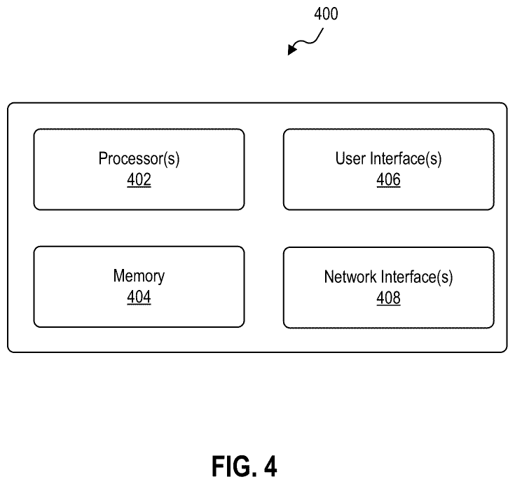

In operation, method 300 is implemented via a computing system, such as computing system 400 shown and described with reference to FIG. 4, or any other type of computing system now known or later developed that is suitable for performing the computing functions disclosed and described herein.

Method 300 begins at block 302, which includes, for a first Deep Reinforcement Learning (DRL) model in a plurality of DRL models, generating a first plurality of trading strategies based at least in part on one or more (i) technical features corresponding to individual securities in a set of securities, (ii) fundamental features of individual securities in the set of securities, and (iii) macroeconomic data. In some embodiments, the one or more technical features corresponding to individual securities in a set of securities, fundamental features of individual securities in the set of securities, and macroeconomic data are stored in a database such as database 102 (FIG. 1) and/or database 206 (FIG. 2).

In some embodiments, generating the first plurality of trading strategies for the first DRL model at block 302 includes using a first DRL agent to learn the first plurality of trading strategies by using a first DRL algorithm to interact with an environment comprising the (i) technical features corresponding to individual securities in the set of securities, (ii) fundamental features of individual securities in the set of securities, and (iii) macroeconomic data. In some examples, the first DRL algorithm comprises at least one of (i) an Advantage Actor Critic (A2C) algorithm, (ii) a Deep Q-Networks (DQN) algorithm, or (iii) a Proximal Policy Optimization (PPO) algorithm. Any other suitable DRL algorithm could be used, too.

In some embodiments, using the first DRL agent to learn the first plurality of trading strategies by using the first DRL algorithm to interact with the environment includes generating at least one DRL policy that maps a state to an action, where (i) the state for the at least one DRL policy corresponds to a set of one or more (a) technical features corresponding to individual securities in the set of securities, (b) fundamental features of individual securities in the set of securities, and (c) macroeconomic data; (ii) the action for the at least one DRL policy corresponds to one of buying or selling a security; and (iii) an individual trading strategy in the first plurality of trading strategies is based at least in part on the at least one DRL policy.

At block 304, method 300 includes for a second DRL model in the plurality of DRL models, generating a second plurality of trading strategies based at least in part on one or more (i) technical features corresponding to individual securities in the set of securities, (ii) fundamental features of individual securities in the set of securities, and (iii) macroeconomic data.

In some embodiments, generating the second plurality of trading strategies for the second DRL model at block 304 includes using a second DRL agent to learn the second plurality of trading strategies by using a second DRL algorithm to interact with the environment comprising the (i) technical features corresponding to individual securities in a set of securities, (ii) fundamental features of individual securities in the set of securities, and (iii) macroeconomic data. In some examples, the second DRL algorithm comprises at least one of (i) an Advantage Actor Critic (A2C) algorithm, (ii) a Deep Q-Networks (DQN) algorithm, or (iii) a Proximal Policy Optimization (PPO) algorithm.

In some embodiments, the first DRL algorithm used in block 302 is a different DRL algorithm than the second DRL algorithm used in block 304. In some embodiments, the first DRL algorithm used in block 302 is the same DRL algorithm than the second DRL algorithm used in block 304, except that the first and second DRL algorithms in such a scenario are configured differently such that they generate different trading policies and/or trading strategies.

In some embodiments, using the second DRL agent to learn the second plurality of trading strategies by using the second DRL algorithm to interact with the environment includes generating at least one DRL policy that maps a state to an action, where (i) the state for the at least one DRL policy corresponds to a set of one or more (a) technical features corresponding to individual securities in the set of securities, (b) fundamental features of individual securities in the set of securities, and (c) macroeconomic data; (ii) the action for the at least one DRL policy corresponds to one of buying or selling a security; and (iii) an individual trading strategy in the first plurality of trading strategies is based at least in part on the at least one DRL policy.

In some embodiments, the plurality of DRL models includes additional DRL models, such as three, four, five, or more DRL models. Some such embodiments additionally include, for each additional DRL model in the plurality of DRL models, generating an additional plurality of trading strategies based at least in part on one or more (i) technical features corresponding to individual securities in the set of securities, (ii) fundamental features of individual securities in the set of securities, and (iii) macroeconomic data

At block 306, method 300 includes determining a momentum score for each security in the set of securities.

In some embodiments, determining a momentum score for each security in the set of securities at block 306 includes, for an individual security in the set of securities: (i) calculating a fast momentum score for the individual security based on a one month return of the security divided by a volatility of the security; (ii) calculating a z-score for the fast momentum score by determining a difference between a mean of momentums of all securities in the set of securities and the fast momentum score for the individual security, and dividing the difference by a standard deviation of momentums of all securities in the set of securities; (iii) calculating a slow momentum score for the individual security based on a six month return of the security divided by the volatility of the security; (iv) calculating a z-score for the slow momentum score for the individual security by determining a difference between a mean of momentums of all securities in the set of securities and the slow momentum score for the individual security, and dividing the difference by the standard deviation of momentums of all securities in the set of securities; and (v) determining the momentum score for the individual security by determining a sum of the z-score for the fast momentum for the individual security and the z-score of the slow momentum for the individual security, and dividing the sum by two to produce the momentum score for the individual security. In some such embodiments, the volatility of the individual security is determined by computing an annualized standard deviation of daily returns of the individual security over a three year period.

At block 308, method 300 includes selecting a candidate subset of securities from the set of securities, wherein individual securities in the candidate subset of securities have a momentum score that satisfies a momentum threshold.

In some embodiments, selecting a candidate subset of securities from the set of securities, at block 308 includes at least one of: (i) selecting at least one security having a momentum score greater than a first threshold for inclusion in the candidate subset of securities as a candidate for a long position; or (ii) selecting at least one security having a momentum score less than a second threshold for inclusion in the candidate subset of securities as a candidate for a short position

At block 310, method 300 includes for each security in the candidate subset of securities, (i) generating a first set of one or more trading signals for the security by applying the first plurality of trading strategies to data associated with the security, (ii) generating a second set of one or more trading signals for the security by applying the second plurality of trading strategies to data associated with the security, and (iii) generating an aggregated trading signal for the security based on the first set of one or more trading signals for the security and the second set of one or more trading signals for the security, wherein the aggregated trading signal indicates a signal strength.

In some embodiments, the aggregated trading signal for an individual security generated at block 310 is (or at least includes) a value between −1 and +1, wherein an aggregated trading signal having a positive value corresponds to a buy indication, wherein an aggregated trading signal having a negative value corresponds to a sell indication, wherein an aggregated trading signal having a value closer to +1 is a stronger buy indication than an aggregated trading signal having a positive value closer to 0, wherein an aggregated trading signal having a value closer to −1 is a stronger sell indication than an aggregated trading signal having a negative value closer to 0.

At optional block 312, method 300 includes determining a portfolio weight for each security in the trading portfolio, wherein for an individual security in the trading portfolio, the portfolio weight for the individual security is proportional to a strength of the aggregated trading signal corresponding to the individual security.

In some embodiments, determining a portfolio weight for each security in the trading portfolio at block 312 includes determining the portfolio weight w for security j according to the equation:

$${w}_{j} = \frac{{e}^{{s}_{j}}}{{\sum }_{i = 1}^{n} {e}^{{s}_{i}}} ,$$

where s₁, . . . , sₙ, are strengths of the aggregated trading signals for each of security 1 through security n in the trading portfolio.

At block 314, method 300 includes adding one or more securities from the candidate subset of securities to a trading portfolio based on the aggregated trading signals for the securities in the subset of securities.

In some embodiments, adding one or more securities from the candidate subset of securities to the trading portfolio based on the aggregated trading signals for the securities in the subset of securities at block 314 includes, for an individual security, adding the individual security to the trading portfolio as a long position when (i) the value of the aggregated trading signal for the individual security a positive value, (ii) the strength of the aggregated trading signal for the individual security is above a threshold strength, and (iii) a number of shares of the individual security added to the trading portfolio is based on the portfolio weight of the individual security.

In some embodiments, adding one or more securities from the candidate subset of securities to the trading portfolio based on the aggregated trading signals for the securities in the subset of securities at block 314 includes, for an individual security, adding the individual security to the trading portfolio as a short position when (i) the value of the aggregated trading signal for the individual security is a negative value, (ii) the strength of the aggregated trading signal for the individual security is below a threshold strength, and (iii) a number of shares shorted in the trading portfolio is based on the portfolio weight of the individual security.

At optional block 316, method 300 includes monitoring changes in the aggregate trading signals for each security in the trading portfolio, and removing an individual security from the trading portfolio based on a change in the aggregate trading signal corresponding to the individual security.

In some embodiments, removing an individual security from the trading portfolio based on a change in the aggregate trading signal corresponding to the individual security at block 316 includes, for an individual security having a long position in the trading portfolio, removing the individual security from the trading portfolio when the aggregated trading signal changes from a positive value to a negative value. And in some embodiments, removing an individual security from the trading portfolio based on a change in the aggregate trading signal corresponding to the individual security at block 316 additionally or alternatively includes, for an individual security having a short position in the trading portfolio, removing the individual security from the trading portfolio when the aggregated trading signal changes from a negative value to a positive value.

### 7. Example Computing Systems

FIG. 4 shows an example computing system 400 configured for implementing one or more (or all) aspects of the methods and processes disclosed herein.

Computing system 400 includes one or more processors 402, one or more tangible, non-transitory computer-readable memory 404, one or more user interfaces 406, and one or more network interfaces 408.

The one or more processors 402 may include any type of computer processor now known or later developed that is suitable for performing one or more (or all) of the disclosed features and functions, individually or in combination with one or more additional processors

The one or more tangible, non-transitory computer-readable memory 404 is configured to store program instructions that are executable by the one or more processors 402. The program instructions, when executed by the one or more processors 402 cause the computing system to perform any one or more (or all) of the functions disclosed and described herein. In operation, the one or more tangible, non-transitory computer-readable memory 404 is also configured to store data that is both used in connection with performing the disclosed functions (e.g., the data for environment 204) and generated via performing the disclosed functions (e.g., the trading signals, the portfolio information and so on).

The one or more user interfaces 406 may include any one or more of a keyboard, monitor, touchscreen, mouse, trackpad, voice interface, or any other type of user interface now known or later developed that is suitable for receiving inputs from a computer user or another computer and/or providing outputs to a computer user or another computer.

The one or more network interfaces 408 may include any one or more wired and/or wireless network interfaces, including but not limited to Ethernet, optical, WiFi, Bluetooth, or any other network interface now known or later developed that is suitable for enabling the computing system 400 to receive data from other computing devices and systems and/or transmit data to other computing devices and systems.

The computing system 400 corresponds to any one or more of a desktop computer, laptop computer, tablet computer, smartphone, and/or computer server acting individually or in combination with each other to perform the disclosed features.

### 8. Conclusions

In accordance with various embodiments of the present disclosure, one or more aspects of the methods described herein are intended for operation as software programs and/or components thereof running on one or more computer processors. Furthermore, software implementations can include, but are not limited to, distributed processing or component/object distributed processing, parallel processing, and/or virtual machine processing, any one of which (or combination thereof) can also be used to implement the methods described herein.

The present disclosure contemplates a tangible, non-transitory machine-readable medium containing instructions so that interconnected computing devices connected via communications networks can exchange voice, video and/or other data with each other in connection with executing the disclosed processes. The instructions may further be transmitted or received over one or more communications networks between and among computing devices.

While the machine-readable media may be shown in example embodiments as a single medium, the term “machine-readable medium” or “machine-readable media” should be taken to include a single medium or multiple media (e.g., a centralized or distributed database, and/or associated caches and servers) that store the one or more sets of instructions. The term “machine-readable medium” or “machine-readable media” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims. The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A method performed by a computing system, the method comprising:
for a first Deep Reinforcement Learning (DRL) model in a plurality of DRL models, generating a first plurality of trading strategies based at least in part on one or more (i) technical features corresponding to individual securities in a set of securities, (ii) fundamental features of individual securities in the set of securities, and (iii) macroeconomic data;
for a second DRL model in the plurality of DRL models, generating a second plurality of trading strategies based at least in part on one or more (i) technical features corresponding to individual securities in the set of securities, (ii) fundamental features of individual securities in the set of securities, and (iii) macroeconomic data;
determining a momentum score for each security in the set of securities;
selecting a candidate subset of securities from the set of securities, wherein individual securities in the candidate subset of securities have a momentum score that satisfies a momentum threshold;
for each security in the candidate subset of securities, (i) generating a first set of one or more trading signals for the security by applying the first plurality of trading strategies to data associated with the security, (ii) generating a second set of one or more trading signals for the security by applying the second plurality of trading strategies to data associated with the security, and (iii) generating an aggregated trading signal for the security based on the first set of one or more trading signals for the security and the second set of one or more trading signals for the security, wherein the aggregated trading signal indicates a signal strength; and
adding one or more securities from the candidate subset of securities to a trading portfolio based on the aggregated trading signals for the securities in the subset of securities.

2. The method of claim 1, further comprising:
determining a portfolio weight for each security in the trading portfolio, wherein for an individual security in the trading portfolio, the portfolio weight for the individual security is proportional to a strength of the aggregated trading signal corresponding to the individual security.

3. The method of claim 2, wherein determining a portfolio weight for each security in the trading portfolio comprises determining the portfolio weight w for security j according to the equation
$${w}_{j} = \frac{{e}^{{s}_{j}}}{{\sum }_{i = 1}^{n} {e}^{{s}_{i}}} ,$$
where s₁, . . . , sₙ, are strengths of the aggregated trading signals for each of security 1 through security n in the trading portfolio.

4. The method of claim 1, wherein adding one or more securities from the candidate subset of securities to the trading portfolio based on the aggregated trading signals for the securities in the subset of securities comprises, for an individual security:
adding the individual security to the trading portfolio as a long position when (i) the value of the aggregated trading signal for the individual security a positive value, (ii) the strength of the aggregated trading signal for the individual security is above a threshold strength, and (iii) a number of shares of the individual security added to the trading portfolio is based on the portfolio weight of the individual security.

5. The method of claim 1, wherein adding one or more securities from the candidate subset of securities to the trading portfolio based on the aggregated trading signals for the securities in the subset of securities comprises, for an individual security:
adding the individual security to the trading portfolio as a short position when (i) the value of the aggregated trading signal for the individual security is a negative value, (ii) the strength of the aggregated trading signal for the individual security is below a threshold strength, and (iii) a number of shares shorted in the trading portfolio is based on the portfolio weight of the individual security.

6. The method of claim 1, wherein an aggregated trading signal for an individual security is a value between −1 and +1, wherein an aggregated trading signal having a positive value corresponds to a buy indication, wherein an aggregated trading signal having a negative value corresponds to a sell indication, wherein an aggregated trading signal having a value closer to +1 is a stronger buy indication than an aggregated trading signal having a positive value closer to 0, wherein an aggregated trading signal having a value closer to −1 is a stronger sell indication than an aggregated trading signal having a negative value closer to 0.

7. The method of claim 1, further comprising:
monitoring changes in the aggregate trading signals for each security in the trading portfolio, and removing an individual security from the trading portfolio based on a change in the aggregate trading signal corresponding to the individual security.

8. The method of claim 7, wherein removing an individual security from the trading portfolio based on a change in the aggregate trading signal corresponding to the individual security comprises:
for an individual security having a long position in the trading portfolio, removing the individual security from the trading portfolio when the aggregated trading signal changes from a positive value to a negative value.

9. The method of claim 7, wherein removing an individual security from the trading portfolio based on a change in the aggregate trading signal corresponding to the individual security comprises:
for an individual security having a short position in the trading portfolio, removing the individual security from the trading portfolio when the aggregated trading signal changes from a negative value to a positive value.

10. The method of claim 1, wherein:
generating the first plurality of trading strategies for the first DRL model comprises using a first DRL agent to learn the first plurality of trading strategies by using a first DRL algorithm to interact with an environment comprising the (i) technical features corresponding to individual securities in the set of securities, (ii) fundamental features of individual securities in the set of securities, and (iii) macroeconomic data;
generating the second plurality of trading strategies for the second DRL model comprises using a second DRL agent to learn the second plurality of trading strategies by using a second DRL algorithm to interact with the environment comprising the (i) technical features corresponding to individual securities in a set of securities, (ii) fundamental features of individual securities in the set of securities, and (iii) macroeconomic data;
wherein the first DRL algorithm comprises one of (i) an Advantage Actor Critic (A2C) algorithm, (ii) a Deep Q-Networks (DQN) algorithm, or (iii) a Proximal Policy Optimization (PPO) algorithm; and
wherein the second DRL algorithm comprises one of (i) an Advantage Actor Critic (A2C) algorithm, (ii) a Deep Q-Networks (DQN) algorithm, or (iii) a Proximal Policy Optimization (PPO) algorithm.

11. The method of claim 10, wherein generating the first plurality of trading strategies for the first DRL model comprises using a first DRL agent to learn the first plurality of trading strategies by using a first DRL algorithm to interact with an environment comprising the (i) technical features corresponding to individual securities in the set of securities, (ii) fundamental features of individual securities in the set of securities, and (iii) macroeconomic data comprises:
generating at least one DRL policy that maps a state to an action;
wherein the state for the at least one DRL policy corresponds to a set of one or more (i) technical features corresponding to individual securities in the set of securities, (ii) fundamental features of individual securities in the set of securities, and (iii) macroeconomic data;
wherein the action for the at least one DRL policy corresponds to one of buying or selling a security; and
wherein an individual trading strategy in the first plurality of trading strategies is based at least in part on the at least one DRL policy.

12. The method of claim 1, wherein determining a momentum score for each security in the set of securities comprises, for an individual security in the set of securities:
calculating a fast momentum score for the individual security based on a one month return of the security divided by a volatility of the security;
calculating a z-score for the fast momentum score by determining a difference between a mean of momentums of all securities in the set of securities and the fast momentum score for the individual security, and dividing the difference by a standard deviation of momentums of all securities in the set of securities;
calculating a slow momentum score for the individual security based on a six month return of the security divided by the volatility of the security;
calculating a z-score for the slow momentum score for the individual security by determining a difference between a mean of momentums of all securities in the set of securities and the slow momentum score for the individual security, and dividing the difference by the standard deviation of momentums of all securities in the set of securities; and
determining the momentum score for the individual security by determining a sum of the z-score for the fast momentum for the individual security and the z-score of the slow momentum for the individual security, and dividing the sum by two to produce the momentum score for the individual security.

13. The method of claim 12, wherein the volatility of the individual security is determined by computing an annualized standard deviation of daily returns of the individual security over a three year period.

14. The method of claim 1, wherein selecting a candidate subset of securities from the set of securities, wherein individual securities in the candidate subset of securities have a momentum score that satisfies a momentum threshold comprises at least one of:
selecting at least one security having a momentum score greater than a first threshold for inclusion in the candidate subset of securities as a candidate for a long position; or
selecting at least one security having a momentum score less than a second threshold for inclusion in the candidate subset of securities as a candidate for a short position.

15. Tangible, non-transitory computer-readable media having program instructions stored therein, wherein the program instructions, when executed by one or more processors, cause a computing system to perform functions comprising:
for a first Deep Reinforcement Learning (DRL) model in a plurality of DRL models, generating a first plurality of trading policies based at least in part on one or more (i) technical features corresponding to individual securities in a set of securities, (ii) fundamental features of individual securities in the set of securities, and (iii) macroeconomic data;
for a second DRL model in the plurality of DRL models, generating a second plurality of trading policies based at least in part on one or more (i) technical features corresponding to individual securities in the set of securities, (ii) fundamental features of individual securities in the set of securities, and (iii) macroeconomic data;
determining a momentum score for each security in the set of securities;
selecting a candidate subset of securities from the set of securities, wherein individual securities in the candidate subset of securities have a momentum score that satisfies a momentum threshold;
for each security in the candidate subset of securities, (i) generating a first set of one or more trading signals for the security by applying the first plurality of trading policies to data associated with the security, (ii) generating a second set of one or more trading signals for the security by applying the second plurality of trading policies to data associated with the security, and (iii) generating an aggregated trading signal for the security based on the first set of one or more trading signals for the security and the second set of one or more trading signals for the security, wherein the aggregated trading signal indicates a signal strength; and
adding one or more securities from the candidate subset of securities to a trading portfolio based on the aggregated trading signals for the securities in the subset of securities.

16. The tangible, non-transitory computer-readable media of claim 15, wherein functions further comprise determining a portfolio weight for each security in the trading portfolio, wherein for an individual security in the trading portfolio, the portfolio weight for the individual security is proportional to a strength of the aggregated trading signal corresponding to the individual security, and wherein adding one or more securities from the candidate subset of securities to the trading portfolio based on the aggregated trading signals for the securities in the subset of securities comprises, for an individual security, at least one of:
adding the individual security to the trading portfolio as a long position when (i) the value of the aggregated trading signal for the individual security a positive value, (ii) the strength of the aggregated trading signal for the individual security is above a threshold strength, and (iii) a number of shares of the individual security added to the trading portfolio is based on the portfolio weight of the individual security; or
adding the individual security to the trading portfolio as a short position when (i) the value of the aggregated trading signal for the individual security is a negative value, (ii) the strength of the aggregated trading signal for the individual security is below a threshold strength, and (iii) a number of shares shorted in the trading portfolio is based on the portfolio weight of the individual security.

17. The tangible, non-transitory computer-readable media of claim 16, wherein the functions further comprise:
monitoring changes in the aggregate trading signals for each security in the trading portfolio, and removing an individual security from the trading portfolio based on a change in the aggregate trading signal corresponding to the individual security.

18. A computing system comprising:
one or more processors; and
tangible, non-transitory computer-readable media having program instructions stored therein, wherein the program instructions, when executed by the one or more processors, cause the computing system to perform functions comprising:
for a first Deep Reinforcement Learning (DRL) model in a plurality of DRL models, generating a first plurality of trading policies based at least in part on one or more (i) technical features corresponding to individual securities in a set of securities, (ii) fundamental features of individual securities in the set of securities, and (iii) macroeconomic data;
for a second DRL model in the plurality of DRL models, generating a second plurality of trading policies based at least in part on one or more (i) technical features corresponding to individual securities in the set of securities, (ii) fundamental features of individual securities in the set of securities, and (iii) macroeconomic data;
determining a momentum score for each security in the set of securities;
selecting a candidate subset of securities from the set of securities, wherein individual securities in the candidate subset of securities have a momentum score that satisfies a momentum threshold;
for each security in the candidate subset of securities, (i) generating a first set of one or more trading signals for the security by applying the first plurality of trading policies to data associated with the security, (ii) generating a second set of one or more trading signals for the security by applying the second plurality of trading policies to data associated with the security, and (iii) generating an aggregated trading signal for the security based on the first set of one or more trading signals for the security and the second set of one or more trading signals for the security, wherein the aggregated trading signal indicates a signal strength; and
adding one or more securities from the candidate subset of securities to a trading portfolio based on the aggregated trading signals for the securities in the subset of securities.

19. The computing system of claim 18, wherein the program instructions, when executed by the one or more processors, cause the computing system to perform functions comprising determining a portfolio weight for each security in the trading portfolio, wherein for an individual security in the trading portfolio, the portfolio weight for the individual security is proportional to a strength of the aggregated trading signal corresponding to the individual security, and wherein adding one or more securities from the candidate subset of securities to the trading portfolio based on the aggregated trading signals for the securities in the subset of securities comprises, for an individual security, at least one of:
adding the individual security to the trading portfolio as a long position when (i) the value of the aggregated trading signal for the individual security a positive value, (ii) the strength of the aggregated trading signal for the individual security is above a threshold strength, and (iii) a number of shares of the individual security added to the trading portfolio is based on the portfolio weight of the individual security; or
adding the individual security to the trading portfolio as a short position when (i) the value of the aggregated trading signal for the individual security is a negative value, (ii) the strength of the aggregated trading signal for the individual security is below a threshold strength, and (iii) a number of shares shorted in the trading portfolio is based on the portfolio weight of the individual security.

20. The computing system of claim 18, wherein the program instructions, when executed by the one or more processors, cause the computing system to perform functions comprising:
monitoring changes in the aggregate trading signals for each security in the trading portfolio, and removing an individual security from the trading portfolio based on a change in the aggregate trading signal corresponding to the individual security.
